(19) United States
(12) Patent Application Publication
(10) Pub. No.: US 2025/0111857 A1
(43) Pub. Date: Apr. 3, 2025

(54) UNIFIED AUDIO SUPPRESSION MODEL

(71) Applicant: Amazon Technologies, Inc., Seattle, WA (US)

(72) Inventors: Ritwik Giri, Redwood City, CA (US); Zhepei Wang, Santa Clara, CA (US); Devansh Shah, Sunnyvale, CA (US); Jean-Marc Valin, Montreal (CA); Michael Mark Goodwin, Scotts Valley, CA (US)

(21) Appl. No.: 18/478,759

(22) Filed: Sep. 29, 2023

(51) Int. Cl. G10L 21/0208; G10L 25/30; H04M 3/56

(52) U.S. Cl. CPC G10L 21/0208; G10L 25/30; H04M 3/568

(57) ABSTRACT

Examples herein provide an approach to enhance an audio mixture of a teleconference application by switching between noise suppression modes using a single model. Specifically, a machine learning (ML) model may be configured to, in response to receiving an audio mixture representation as input, suppress either a background noise of the audio mixture or suppress all noise of the audio mixture except a user's voice. In some examples, the ML model may be trained on speech and background noise training data during a training phase. In addition, the ML model may be trained on a user's voice during an enrollment phase. In addition, during an inference phase, the ML model may enhance the audio mixture by suppressing a portion of the audio mixture.

### BACKGROUND

Teleconference applications typically include options to filter out distracting sounds. For example, users may want to suppress background noises, including typing or tapping sounds, noise from fans or air-conditioning units, footsteps, or other sounds that might be present in a teleconference environment. However, speech-like sounds, such as children playing in the background, or noise from a TV, may not be filtered out in a background noise suppression mode. In order to filter speech-like sounds, an additional speech-based filter may be applied.

### BRIEF DESCRIPTION OF THE DRAWINGS

Various features will now be described with reference to the following drawings. Throughout the drawings, reference numbers may be re-used to indicate correspondence between referenced elements. The drawings are provided to illustrate examples described herein and are not intended to limit the scope of the disclosure.

FIG. 1 illustrates an example computing environment in which embodiments of the present disclosure can be implemented by an audio suppression system.

FIG. 2 depicts an example block diagram of components of a training system of the audio suppression system of FIG. 1 to train a machine learning (ML) model.

FIG. 3 depicts an example block diagram of components of the audio suppression system of FIG. 1 to enroll and suppress an audio mixture using a unified ML model.

FIG. 4 depicts an example block diagram of components of an enrollment system of the audio suppression system of FIG. 1 to enroll a user's voice.

FIG. 5 depicts an example block diagram of components of an inference system of the audio suppression system of FIG. 1 to suppress a portion of an audio mixture.

FIG. 6 is an example flow diagram depicting a process for suppressing portions of an audio mixture using a unified ML model, in accordance with some embodiments of the present disclosure.

### DETAILED DESCRIPTION

Noise suppression and/or enhancement settings in teleconference applications may be configured to filter out sounds and/or enhance sounds that are picked up by a microphone. For example, a background noise suppression setting may filter out non-speech sounds from being transmitted over the call. In addition, a personalized suppression setting may filter out background noise and speech-like sounds from being transmitted over the call while preserving a user's voice. This highlights a user's voice in the teleconference application while filtering out all other noises, whether speech-like or non-speech-like.

Although a personalized suppression filter may provide an improved conversation experience, many teleconference application settings require non-personalized suppression. For example, more than one user may be present in a teleconference environment. In this example, a personalized suppression filter is not applicable. In addition, current noise suppression systems lack the ability to seamlessly switch between suppression modes. For example, current noise suppression systems may utilize machine learning (ML) or other artificial intelligence (AI) based models to suppress noises. However, separate models are typically needed for different noise suppression applications, such as one model for background noise suppression and another model for voice suppression. To suppress both background noises and voices, both models may need to run at the same time, which may utilize a large amount of computing resources and time. In fact, given the large amount of computing resources and/or time that may be utilized in running multiple models concurrently, the outputs of the models may be delayed to the point that no or little audio is suppressed in real-time as user(s) are speaking. Thus, running multiple models concurrently may render the audio suppression ineffective.

Examples herein provide an approach to enhance an audio mixture of a teleconference application by switching between noise suppression modes using a single model. Specifically, an ML model may be configured to, in response to receiving an audio mixture representation as input, suppress either a background noise of the audio mixture or suppress all noise of the audio mixture except a user's voice.

In some examples, the ML model may be trained on speech and background noise training data during a training phase. During this phase, training data such as clean speech data and/or background noise data may be used to create realistic “audio mixtures” of sounds that may simulate a teleconference environment. Training data may be used to condition the ML model to suppress portions of the audio mixture, such as background noise and/or voices. The ML model may also be trained to enhance or preserve a single voice while suppressing all other noises, including extraneous voices. In some cases, this may be helpful to highlight a single user's voice while filtering out other voices that may ordinarily be picked up over a teleconference call, even when a background noise suppression mode is set.

In addition, the ML model may be trained on a user's voice during an enrollment phase. During this phase, a voice sample of a target user may be input into the ML model in order for the ML model to be trained on the user's voice. In addition, the ML model may be trained to suppress noises based on a personalized or non-personalized mode. For example, to train the ML model to suppress only background noises while preserving all voices, including the user (“non-personalized mode”), the voice sample may be concatenated with a flag to indicate to the ML model that only background noise should be suppressed. On the other hand, to train the ML model to suppress background noises and other voices besides the user's voice (“personalized mode”), the voice sample may be concatenated with a different flag to indicate to the ML model that all noise apart from the user's voice should be suppressed.

In addition, during an inference phase, the ML model may enhance the audio mixture by suppressing a portion of the audio mixture. The inference phase may occur after the enrollment phase, and may occur, for example, during a live teleconference meeting. During this phase, the user may decide on the audio selection, such as the non-personalized mode or the personalized mode. Depending on the selection, portions of the audio mixture transmitted over the teleconference application may be suppressed. During this phase, a user may also toggle between personalized and non-personalized modes depending on the desired selection.

As noted herein, in some aspects, a unified ML model may be trained on background noise data, clean speech data, a user's voice sample data, etc. in order to suppress noises in a personalized mode or a non-personalized mode. Rather than using multiple models to suppress different parts of an audio mixture, the audio suppression system described herein can therefore use the unified ML model to suppress the different audio mixture parts. Because of this multi-mode training and the fact that the unified ML model can be a single model, the unified ML model as used with a teleconference application may consume fewer computing resources than a multi-model approach and/or may produce faster suppressed audio outputs than a multi-model approach. As a result, users can toggle between audio selection modes during a teleconference call in real-time as user(s) are speaking without experiencing audio suppression delays that could otherwise render the audio suppression ineffective.

While the background noise suppression functionality described herein is described as being performed in association with a teleconference application, this is not meant to be limiting. For example, any or all of the background noise functionality described herein can be performed in association with any type of communication application or service in which user voices and/or background noises may be present, such as a telephone call (e.g., a landline service, a voice-over-Internet Protocol (VOIP) service, etc.), an audio chat service, a television broadcast, a radio broadcast, and/or the like. In addition, the background noise functionality described herein can be performed on live audio (e.g., audio received by the system in real-time, such as on audio received by the system within 1 microsecond, 1 millisecond, 1 second, and/or any other short timeframe of the audio being generated) or recorded audio.

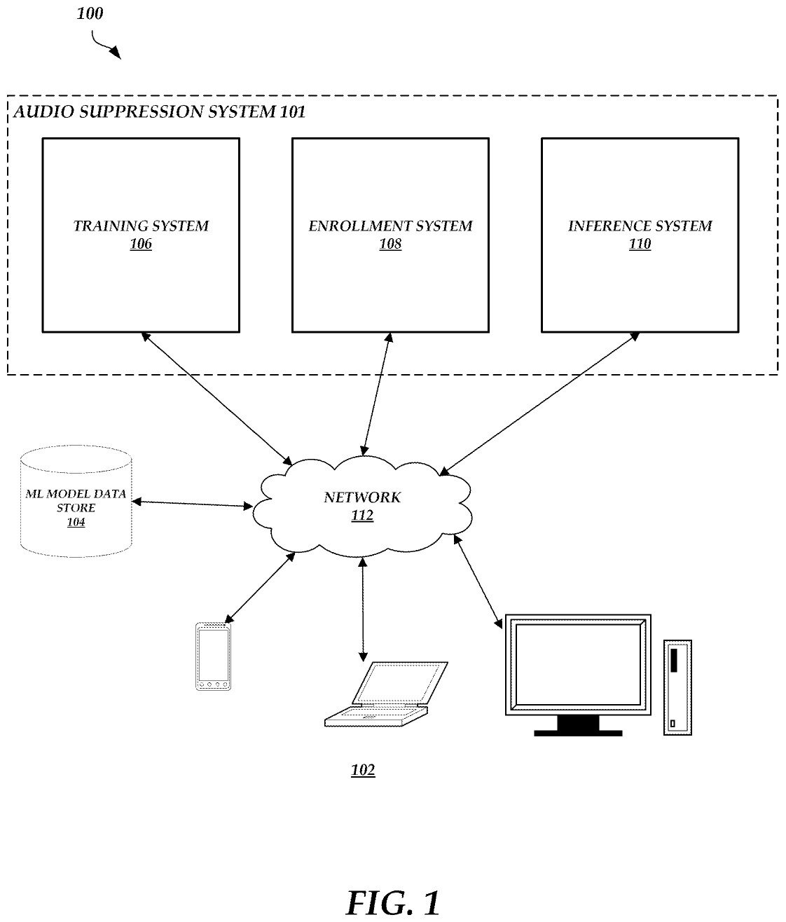

FIG. 1 depicts an example computing environment 100 in which embodiments of the present disclosure can be implemented by an audio suppression system 101. The computing environment 100 may include user device(s) 102, the audio suppression system 101, and network 112. The audio suppression system 101 may further include training system 106, enrollment system 108, and inference system 110. In some embodiments, the training system 106, the enrollment system 108, the inference system 110, and the ML model data store 104, may be accessed by device(s) 102, such as via network 112. In some embodiments, training system 106, enrollment system 108, inference system 110, ML model data store 104, may be implemented by one or more computing devices, such as user device(s) 102 for conducting and accessing workflows.

Various example user device(s) 102 are shown in FIG. 1, including a desktop computer, laptop, and a mobile phone, each provided by way of illustration. In general, the user device(s) 102 can be any computing device such as a desktop, laptop or tablet computer, personal computer, wearable computer, server, personal digital assistant (PDA), hybrid PDA/mobile phone, mobile phone, electronic book reader, set-top box, voice command device, camera, digital media player, and the like.

User device(s) 102 may include any memory such as RAM, ROM or other persistent or non-transitory memory. In some implementations, the memory of device(s) may be configured to execute processes as described herein. In some implementations, memory may be stored on a remote server(s) and accessible by user device(s) 102 or other components within computing environment 100.

In some embodiments, the network 112 includes any wired network, wireless network, or combination thereof. For example, the network 112 may be a personal area network, local area network, wide area network, over-the-air broadcast network (e.g., for radio or television), cable network, satellite network, cellular telephone network, or combination thereof. As a further example, the network 112 may be a publicly accessible network of linked networks, possibly operated by various distinct parties, such as the Internet. In some embodiments, the network 112 may be a private or semi-private network, such as a corporate or university intranet. The network 112 may include one or more wireless networks, such as a Global System for Mobile Communications (GSM) network, a Code Division Multiple Access (CDMA) network, a Long Term Evolution (LTE) network, or any other type of wireless network. The network 112 can use protocols and components for communicating via the Internet or any of the other aforementioned types of networks. For example, the protocols used by the network 112 may include Hypertext Transfer Protocol (HTTP), HTTP Secure (HTTPS), Message Queue Telemetry Transport (MQTT), Constrained Application Protocol (CoAP), and the like. Protocols and components for communicating via the Internet or any of the other aforementioned types of communication networks are well known to those skilled in the art and, thus, are not described in more detail herein.

In some embodiments, audio suppression system 101 may be a part of a cloud provider network (e.g., a “cloud”), which may correspond to a pool of network-accessible computing resources (such as compute, storage, and networking resources, applications, and services), which may be virtualized or bare-metal. The cloud can provide convenient, on-demand network access to a shared pool of configurable computing resources that can be programmatically provisioned and released in response to customer commands. These resources can be dynamically provisioned and reconfigured to adjust to provide various services, such as collecting sample data associated with network-based or online experiments and performing statistical analysis techniques as disclosed in the present disclosure. The computing services provided by the cloud that may include training system 106, enrollment system 108, inference system 110, and can thus be considered as both the applications delivered as services over a publicly accessible network (e.g., the Internet, a cellular communication network) and the hardware and software in cloud provider data centers that provide those services.

Additionally, user device(s) 102 may communicate with the training system 106, enrollment system 108, and/or inference system 110 via various interfaces such as application programming interfaces (API) as a part of cloud-based services. In some embodiment, training system 106, enrollment system 108, and inference system 110 may interact with the user device(s) 102 through one or more user interfaces, command-line interfaces (CLI), application programing interfaces (API), and/or other programmatic interfaces for requesting actions, requesting services, initiating network-based or online experiments, requesting statistical results of network-based or online experiments, providing feedback data, and/or the like.

Although not shown, in some embodiments, user device(s) 102 may host or communicate with a teleconference application or program. For example, a user of user device(s) 102 may utilize a video conferencing application, a phone or audio application, and the like. In some embodiments, audio suppression system 101 may be integrated with a teleconference application such that audio mixture to be transmitted via the teleconference application may be suppressed by the audio suppression system 101.

As shown in FIG. 1, the computing environment 100 includes the ML model data store 104. In some embodiments, ML model data store 104 may be configured to store an ML model. In some examples, the ML model data store 104 can store any type of model designed to suppress an audio mixture in addition to or in place of the ML model, such as an artificial intelligence model, a natural language processing model, a language model, neural network, a transformation model, etc. If the ML model data store 104 stores another type of model in place of the ML model, the stored model may be used in place of the ML model by the components described herein. In some embodiments, ML model data store 104 may be accessed by other components of computing environment 100 via network 112, such as the training system 106, enrollment system 108, inference system 110, and user device(s) 102. While the ML model data store 104 is depicted as being external to the audio suppression system 101, this is not meant to be limiting. For example, the ML model data store 104 can be internal to the training system 106, the enrollment system 108, or the inference system 110, or internal to another system within the audio suppression system 101.

Training system 106 may be configured to train the ML model stored in ML model data store 104. For example, the ML model may be trained to suppress certain portions of an audio mixture of a teleconference application using training data such as background noise and speech recordings. The training system 106 may be a single computing device, or it may include multiple distinct computing devices, such as computer servers, logically or physically grouped together to collectively operate as a system. In some embodiments, the features and services provided by the training system 106 may be implemented as web services consumable via the network 112. In further embodiments, the training system 106 is provided by one more virtual machines implemented in a hosted computing environment. The hosted computing environment may include one or more rapidly provisioned and released computing resources, which computing resources may include computing, networking and/or storage devices. A hosted computing environment may also be referred to as a cloud computing environment. More details referring to training system 106 will be discussed below.

Enrollment system 108 may be configured to register a user's voice. For example, during an enrollment phase, the enrollment system 108 may receive a sample of user's voice. In some embodiments, enrollment system 108 may further train the ML model to recognize the user's voice during the enrollment phase. In addition, the enrollment system 108 may train the ML model to suppress certain portion of an audio mixture containing the user's voice. For example, the ML model may be trained to suppress all noise while highlighting or preserving the user's voice, or to suppress all background noise while preserving all voices, including the user's. The enrollment system 108 may be a single computing device, or it may include multiple distinct computing devices, such as computer servers, logically or physically grouped together to collectively operate as a system. In some embodiments, the features and services provided by the enrollment system 108 may be implemented as web services consumable via the network 112. In further embodiments, the enrollment system 108 is provided by one more virtual machines implemented in a hosted computing environment. The hosted computing environment may include one or more rapidly provisioned and released computing resources, which computing resources may include computing, networking and/or storage devices. A hosted computing environment may also be referred to as a cloud computing environment. More details referring to enrollment system 108 will be discussed below.

Inference system 110 may be configured to enhance an audio mixture based on an enhanced audio selection. For example, an enhanced audio selection may correspond to a non-personalized more or a personalized mode. This allows a user to choose whether to suppress all background noises including other voices besides the user's, or to suppress only background noises while preserving voices. In some implementations, the inference system 110 may receive the selection during a teleconference session, such as during a video or audio call. In some implementations, the inference system 110 may receive the selection before the start of a teleconference session. In some implementations, such as for a communication application or other application other than a teleconference session, the inference system 110 may receive the selection during the session, before the session, or at any other appropriate time. In some embodiments, the inference system may feed an audio mixture and an indication of the enhanced audio selection as input into the ML model, causing the ML model to output a suppressed/enhanced audio mixture. The inference system 110 may be a single computing device, or it may include multiple distinct computing devices, such as computer servers, logically or physically grouped together to collectively operate as a system. In some embodiments, the features and services provided by the inference system 110 may be implemented as web services consumable via the network 112. In further embodiments, the inference system 110 is provided by one more virtual machines implemented in a hosted computing environment. The hosted computing environment may include one or more rapidly provisioned and released computing resources, which computing resources may include computing, networking and/or storage devices. A hosted computing environment may also be referred to as a cloud computing environment. More details referring to inference system 110 will be discussed below.

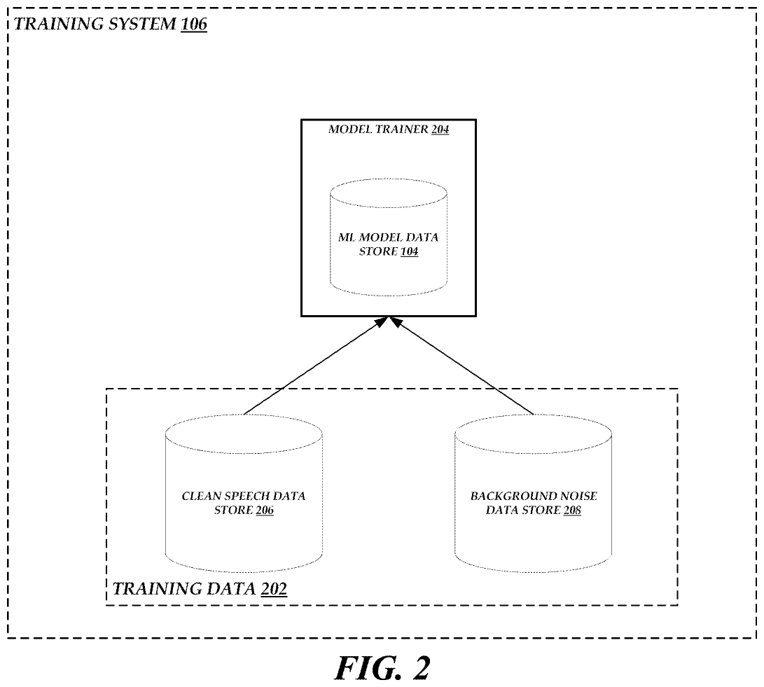

FIG. 2 depicts an example block diagram of components of a training system 106 of the audio suppression system 101 of FIG. 1 to train a machine learning model. In some embodiments, training system 106 includes model trainer 204 and training data 202.

Model trainer 204 may be configured to train the ML model stored in ML model data store 104. For example, model trainer 204 may feed training data as input into the ML model in order to train the ML model. It is noted that although ML model data store 104 is illustrated within enrollment model trainer 204, this is to illustrate that model trainer 204 may access ML model data store 104, and ML model data store 104 may be located elsewhere and accessible via network 112.

As shown in FIG. 2, training data 202 may refer to data stored in various databases, such as clean speech data store 206 and background noise data store 208. In some embodiments, clean speech data may be stored in clean speech data store 206. In some embodiments, clean speech data may include any human speech samples, such as a talking sample, a single voice sample, multiple voice samples, a singing sample, and the like. In some embodiments, background noise data may be stored in background noise data store 208. In some embodiments, background noise data may include samples of environmental noises, alarms, traffic noise, music, white noise, device noise, typing sounds, and the like. Training data, in some cases, may be labeled. For example, the training data corresponding to audio of a single voice, a high-pitched voice, a low-pitched voice, a male voice, a female voice, a loud voice, a soft voice, a medium voice, a child's voice, an adult's voice, a teenager's voice, a whisper, a shout, a singing voice, etc. may be labeled as “clean speech.” Similarly, training data corresponding to an audio of a computer fan, keyboard typing, air conditioning, TV, radio, traffic, honking, footsteps, creaking, cooking sounds, tapping, phone notification sounds, etc. may be labeled as “background noise.” In some implementations, the model trainer 204 may combine portions of the training data 202 to form combined training data that the model trainer 204 uses to train the ML model. For example, the model trainer 204 may combine one or more different types of clean speech data to create a chorus of speakers. In some implementations, the model trainer 204 may combine one or more different types of clean speech data and one or more different types of background noise data to create an audio mixture that represents ambient noise and speakers that may be present during a teleconference call. Each combination of one or more types of clean speech data and/or one or more types of background noise data may be referred to herein as a training data item. The model trainer 204 can form multiple different combinations of type(s) of clean speech data and/or type(s) of background noise data (e.g., can form multiple training data items) that collectively form the combined training data. The model trainer 204 can randomly select different types of clean speech data and/or background noise data to combine or can select specific types of clean speech data and/or background noise data to combine to generate a specific scenario (e.g., multiple voices speaking with keyboard typing in the background).

In some embodiments, model trainer 204 may apply combined training data to the ML model stored in ML model data store 104. In some embodiments, model trainer 204 may apply sound effects to the training data 202 items fed into the ML model. For example, sound effects may include reverb, echo, tremolo, delay, chorus and other modulation effects. Training data 202 items may be modified by sound effects in some cases. For example, echo may be added to a clean speech sample of a person speaking. This may add a repeated reverberation to the clean speech sample. In some cases, model trainer may apply more than one sound effect to individual training data items. Different sound effects may be applied to various training data 202 items.

In some embodiments, model trainer 204 may train the ML model to suppress background noises. For example, model trainer 204 may create a mixture of clean speech data and background noise data from the 204 and 206 data stores, respectively, to create a realistic audio mixture. In this example, the ML model may be trained to output, in response to the audio mixture input, an enhanced audio mixture with suppressed background noise. In some examples, the model trainer 204 may be configured to train the ML model to enhance a test voice and/or suppress other noises. To train the ML model, the model trainer 204 may provide one or more types of clean speech data and/or background noise data as an input to the ML model and identify for the ML model a target that represents a desired output of the ML model (e.g., a type of clean speech data). For example, the model trainer 204 may input into the ML model a voice sample relating to a test speaker 1 along with a mixture of other background sounds and identify the voice sample relating to the test speaker 1 as the target. In some implementations, the training mixture of noises and sounds selected by the model trainer 204 may be random. In some implementations, the training mixture of sounds and noises selected by the model trainer 204 may be curated, such as to train the ML model in specific environments. In this example, during training, the ML model may be configured to suppress other background noises and preserve the voice of the test speaker for output. In some implementations, the model trainer 204 may compare the output of the ML model with the target voice. In some examples, if the output of the ML model and the target do not match, such as within a certain error rate, the model trainer 204 may continue to train the ML, such as by changing hyperparameters of the model, etc.

In some embodiments, model trainer 204 may train the ML model to suppress voices of an audio mixture. For example, model trainer 204 may create a mixture of clean speech data and background noise data from the 204 and 206 data stores, respectively, to create a realistic audio mixture. In some cases, the mixture of audio used for training may contain a variety of clean speech and background noises. In addition, each audio sample may be identified or labeled by the types of training data 202 used in the mixture. For example, an audio mixture may contain audio of a child's voice and computer typing. The audio samples in this mixture may contain the labels of clean speech and background noise, respectively. The model trainer 204 may input the audio mixture with the labels into the ML model as multiple audio signals corresponding to the relevant training data types (where the audio signals can either be in the same audio file in different channels or in different audio files). In other examples, model trainer 204 may blend, combine, or otherwise add the audio signals into the audio mixture in a single channel before feeding the audio mixture into the ML model. In addition, the model trainer 204 may input a flag or other target indicator to the ML model in order to cause the ML model to output suppressed audio corresponding to the flag. For example, in response to a flag as an input, the ML model may be trained to output an enhanced audio mixture with suppressed voices. In another example, a voice sample relating to a test speaker 1 may be input into the ML model along with a mixture of other background sounds. In some implementations, the training mixture of noises and sounds maybe random. In some implementations, the training mixture of sounds and noises may be curated, such as to train the ML model in specific environments. In this example, during training, the ML model may be configured to suppress other background noises and preserve the voice of the test speaker. In this example, ML model may be trained to output only the clean test speaker voice. In some implementations, the training mixture of noises and sounds selected by the model trainer 204 may be random. In some implementations, the training mixture of sounds and noises selected by the model trainer 204 may be curated, such as to train the ML model in specific environments. In this example, during training, the ML model may be configured to suppress other background noises and preserve the voice of the test speaker for output. In some implementations, the model trainer 204 may compare the output of the ML model with the target voice. In some examples, if the output of the ML model and the target do not match, such as within a certain error rate, the model trainer 204 may continue to train the ML, such as by changing hyperparameters of the model, etc.

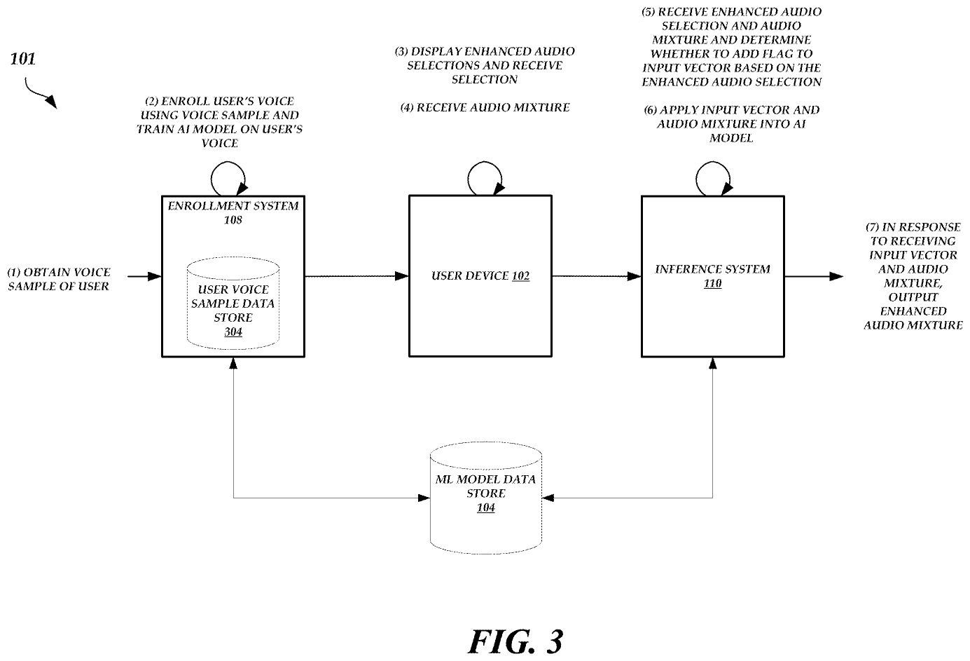

FIG. 3 depicts an example block diagram of components of the audio suppression system 101 of FIG. 1 to enroll and suppress an audio mixture using a unified ML model. It is noted that the ML model stored in ML model data store 104 may be trained according to the processes described with respect to FIG. 2.

Although not illustrated, processes performed by various components of computing environment 100 may be executed by one or more hardware processors configured with computer-executable instructions. In some examples, the one or more hardware processors may be located on a user device 102 configured to execute processes within computing environment 100.

As illustrated in FIG. 3, a voice sample of a user may be obtained at (1). Although not pictured, the voice sample of the user may be obtained by a user device 102 with a microphone or other device configured to receive sounds. In some embodiments, the voice sample of the user may be applied to the enrollment system 108.

As shown, the enrollment system 108 may be configured to enroll a user's voice at (2). In some embodiments, the enrollment system 108 may store the voice sample of the user in the user voice sample data store 304. In some embodiments, the enrollment system 108 may identify the user voice sample with an identifier. The identifier may include a user's name, a number, a shorthand name or phrase, and/or any other piece of information that associates the voice sample with a particular user.

In addition, at (2), the enrollment system 108 may train the ML model based on the user's voice sample. In some embodiments, the enrollment system 108 may input the voice sample of the user into an ML model stored in ML model data store 104. By feeding the voice sample of the user into the ML model at an enrollment phase, the enrollment system 108 may train the ML model to recognize the user's voice in subsequent phases, such as the inference phase, for multiple audio selection modes, such as personalized and non-personalized modes. For example, the enrollment system 108 may train the ML model to suppress a certain portion of an audio mixture containing the user's voice. Whereas during the training phase, the ML model was not trained specifically for the user, the enrollment system 108 may add the user's voice as another piece of training data as input to the ML model. In some embodiments, in response, to an audio mixture input, a voice sample of the user, and a flag or indicator that selects a type of mode (e.g., personalized versus non-personalized), the enrollment system 108 may train the ML model to output a suppressed and/or enhanced audio mixture. For example, the ML model may be trained to suppress all noise while highlighting or preserving the user's voice, or to suppress all background noise while preserving all voices, including the user's In some embodiments, in response to the voice sample input, the ML model may be trained to recognize the user's voice based on the voice sample of the user. In some embodiments, the ML model may be trained to suppress a portion of an audio mixture based on the user's voice. For example, enrollment system 108 may input training data corresponding to background noise, other clean speech voice samples, and/or the user's voice sample into the ML model. Here, the target output is suppression of the background noise of the audio mixture while preserving the user's voice and/or other speech-like sounds. In another example, the enrollment system 108 may input the same training data corresponding to the background noise, other clean speech data, and the user's voice sample into the AI mode, but the target would be suppression of all background noises and speech-like sounds while preserving only the user's voice.

An enhanced audio selection may be displayed by the user device(s) 102 at (3). In some embodiments, an enhanced audio selection may refer to a type of noise suppression. For example, a user of the user device 102 may utilize a teleconference application in which the user desires to suppress a certain portion of the audio mixture being transmitted through the teleconference application. In this example, an enhanced audio selection may refer to a personalized mode (e.g., suppression of the background noise and all speech-like sounds while preserving the user's voice) or a non-personalized mode (e.g., suppression of the background noise while any speech-like sound is preserved), and the like. In some embodiments, the enhanced audio selection may be displayed by the user device(s) 102 within a teleconference application interface.

Also at (3), in response to displaying the enhanced audio selection, the user device(s) 102 may receive the enhanced audio selection. In some embodiments, a user may select the enhanced audio selection as displayed within the teleconference application interface. In some embodiments, a user may set the enhanced audio selection before a teleconference call or meeting has begun. In some embodiments, a user may toggle or switch between the enhanced audio selection during a teleconference call or meeting. In some implementations, the inference system 110 may receive the selection during a teleconference session, such as during a video or audio call. In some implementations, the inference system 110 may receive the selection before the start of a teleconference session. In some implementations, such as for a communication application or other application other than a teleconference session, the inference system 110 may receive the selection during the session, before the session, or at any other appropriate time.

In some embodiments, the user device(s) 102 may, at (4), receive an audio mixture. In some embodiments, the audio mixture includes any noises or sounds picked up by a microphone of user device(s) 102, such as during a teleconference call or meeting. In some embodiments, the audio mixture may include the user's voice and/or other noises that are picked up by the microphone of user device(s) 102.

Inference system 110 may, at (5), receive the enhanced audio selection and audio mixture from the user device(s) 102. In some embodiments, the inference system 110 may generate an input vector based on the enhanced audio selection and the audio mixture, where the input vector is the input to the ML model stored in ML model data store 104. An input vector may include any input value that is fed into the ML model, such as an identifier of an enrolled user, an enhanced audio selection value, an identifier representing the audio mixture, a representation of the audio mixture (e.g., where one or more elements of the input vector can include different portions of the audio mixture separated by phonemes or other parts of speech, silence, time, etc.), etc. In some embodiments, the inference system 110 may add a flag to the input vector based on the enhanced audio selection. In some examples, the flag may be concatenated to the input vector, such as at the beginning, middle, or end of the input vector. The flag may, in some instances, be located adjacent to a portion of the audio to be suppressed. For example, the flag may indicate to the ML model which part of the audio mixture is to be suppressed based on the enhanced audio selection. In addition, the inference system 110 may, at (6), apply the input vector, with the flag, and the audio mixture into the ML model stored in ML model data store 104.

In response to receiving the input vector and audio mixture, at (7), the ML model may output an enhanced audio mixture. In some embodiments, the enhanced audio mixture may be in a personalized mode, in which only the user's voice is preserved while all other noises are suppressed. In some embodiments, the enhanced audio mixture may be in a non-personalized mode, in which the background noise is suppressed while the user's voice and other speech-like sounds are preserved. In some embodiments, the enhanced audio mixture may be transmitted to a teleconference application.

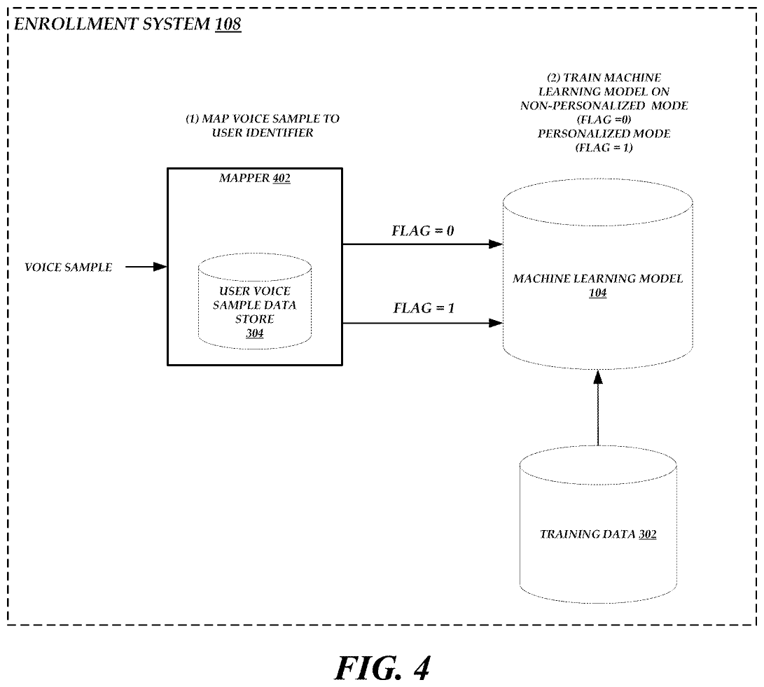

FIG. 4 depicts an example block diagram of components of an enrollment system of the audio suppression system of FIG. 1 to enroll a user's voice into the audio suppression system 101.

Although not illustrated, processes performed by various components of enrollment system 108 may be executed by one or more hardware processors configured with computer-executable instructions. In some examples, the one or more hardware processors may be located on a user device 102 or within computing environment 100 configured to execute processes within enrollment system 108.

As shown in FIG. 4, enrollment system 108 may receive a voice sample, such as a voice sample of a user. For example, in some embodiments, enrollment system 108 may receive the voice sample from a component of the user device(s) 102, such as a microphone or other device configured to receive sounds. In some embodiments, a voice sample includes a sample of the user speaking a phrase, or speaking for a predetermined amount of time, etc. In some embodiments, the voice sample includes more than one voice sample of the user.

In some embodiments, mapper 402 may receive the voice sample of the user. In some embodiments, mapper 402 may be configured to map a voice sample of the user to a user identifier, shown at (1). For example, mapper 402 may store the voice sample of the user in a user voice sample data store 304. In some embodiments, mapper 402 may generate, create, or otherwise assign a unique identifier to the voice sample of the user. In some embodiments, enrollment system 108 may create a profile for the user based on the voice sample.

In some embodiments, enrollment system 108 may train the ML model on the voice sample of the user at (2). In some embodiments, the ML model may be trained once on a user's voice using the voice sample and may be configured to recognize the user's voice in the future. In some embodiments, enrollment system 108 may train the ML model on the voice sample of the user in a non-personalized mode. As used herein, a non-personalized mode of an audio mixture refers to an audio mixture in which background noise is suppressed while voices and other speech-like sounds are not suppressed. In some embodiments, enrollment system 108 may train the ML model on the voice sample of the user in a personalized suppression mode (all background noise is suppressed except the voice of the user).

In some embodiments, to train the ML model on the user's voice, enrollment system 108 may input the voice sample of the user, concatenated with a flag, into the ML model as input. In some embodiments, the flag may be a binary bit (such as 0 or 1) or other indicator to be concatenated onto the input to the ML model. In some embodiments, the flag indicates to the ML model which suppression mode should be the target output. For example, to train the ML model on the background noise suppression mode, the enrollment system 108 may input the user's voice sample concatenated with a “0” flag into the ML model, causing the ML model to output an audio mixture with only the background noise suppressed. In another example, to train the ML model on the personalized suppression mode, the enrollment system 108 may input the user's voice sample concatenated with a “1” flag into the ML model, causing the ML model to output an audio mixture with the background noise and other speech-like noise suppressed.

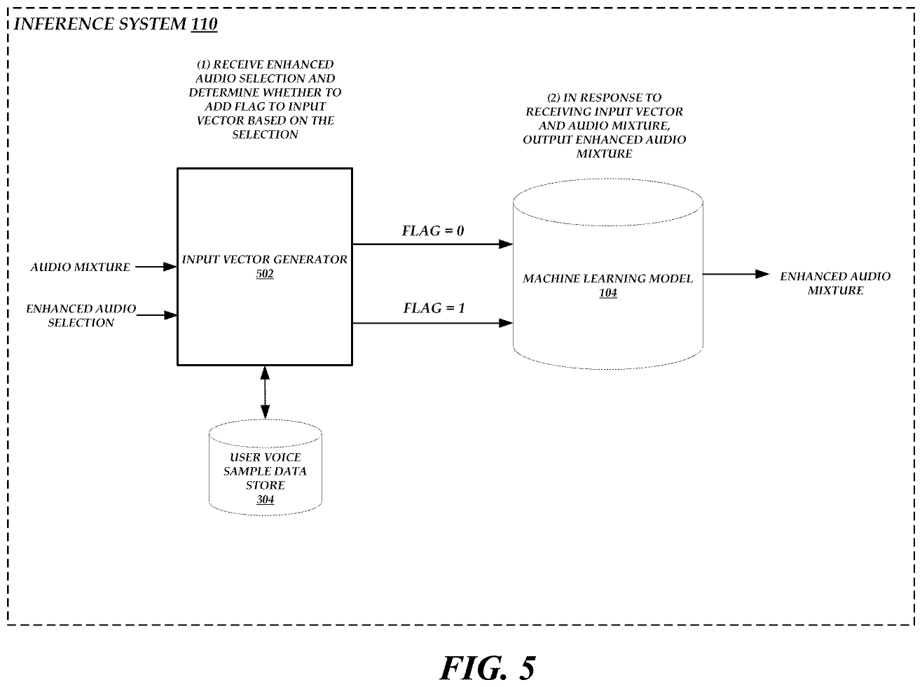

FIG. 5 depicts an example block diagram of components of an inference system of the audio suppression system of FIG. 1 to suppress a portion of an audio mixture.

As described in FIG. 3, the inference system 110 may receive an audio mixture and an enhanced audio selection from user device(s) 102. As shown in FIG. 5, the input vector generator 502 may receive the audio mixture and the enhanced audio selection at (1). In addition, input vector generator 502 may access the user voice sample data store 304 to obtain the voice sample and/or identifier of a user. In some embodiments, at (1), the input vector generator 502 may generate an input vector to be input into the ML model stored in ML model data store 104. In some embodiments, the input vector includes a user voice identifier concatenated with a flag. In some embodiments, this may inform the ML model of the target user's voice and the type of noise to suppress. For example, the input vector generator 502 may determine whether to add a flag to the input vector based on the enhanced audio selection. Similar to the flagging process as described with reference to FIG. 4, input vector generator 502 may concatenate a flag (e.g., binary bit) indicating to the ML model which portion of the audio mixture is to be suppressed. For example, if the enhanced audio selection is non-personalized mode, the input vector generator 502 may add a “0” flag (or a “1” flag) onto the input vector. In another example, if the enhanced audio selection is personalized mode, the input vector generator 502 may add a “1” flag (or a “0” flag) onto the input vector. The input vector generator 502 may feed the input vector into the ML model stored in the ML model data store 104.

At (2), in response to the receiving the input vector and the audio mixture as input into the ML model, the ML model may output an enhanced audio mixture. In some embodiments, the enhanced audio mixture may be in a personalized mode, in which only the user's voice is preserved while all other noises are suppressed. In some embodiments, the enhanced audio mixture may be in a non-personalized mode, in which the background noise is suppressed while the user's voice and other speech-like sounds are preserved. In some embodiments, the enhanced audio mixture may be transmitted to a teleconference application.

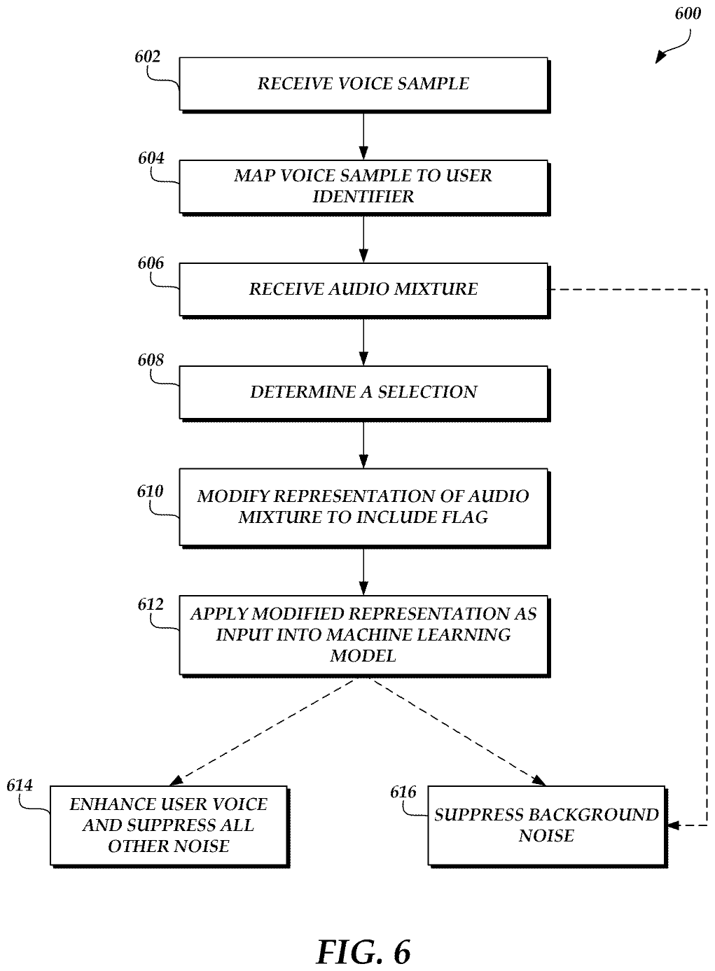

FIG. 6 is an example flow diagram depicting a process for suppressing portions of an audio mixture using a unified ML model, in accordance with some embodiments of the present disclosure. In an embodiment, routine 600 may be executed by audio suppression system 101 and various components of computing environment 100. Specifically, in some embodiments, routine 600 may be executed by a processor, not shown, of audio suppression system 101.

At block 602, the audio suppression system 101 receives a voice sample. In some embodiments, the voice sample is a voice sample of a user using a teleconference application. It is noted that in some implementations, block 602 may be an optional step in the process 600. For example, the audio suppression system 101 may suppress background noise of an audio mixture using the unified ML model without receiving a voice sample.

At block 604, the enrollment system 108 maps the voice sample to a user identifier. For example, the enrollment system 108 may generate, assign, or otherwise associate the voice sample to a user identifier. The identifier may include a user's name, a number, a shorthand name or phrase, and/or any other piece of information that associates the voice sample with a particular user. It is noted that in some implementations, block 604 may be an optional step in the process 600. For example, the audio suppression system 101 may suppress background noise of an audio mixture without receiving a voice sample or mapping a voice sample to a user identifier.

At block 606, the user device 102 receives an audio mixture. In some embodiments, the audio mixture may be detected by an audio sensor, such as a microphone. It is noted that in some implementations, process 600 may start at block 606. For example, in some implementations, process 600 may skip an enrollment phase as described in blocks 602 and 604. In some implementations, the process 600 may proceed directly from block 606 to block 616, as represented by the dotted line depicted in FIG. 6. In this implementation, the background noise may be suppressed during from the audio mixture without the user selecting a type of suppression or the audio mixture being modified and/or provided as an input to the ML model. In other implementations, as illustrated in FIG. 6, process 600 may advance from block 606 to block 616 through blocks 608-612.

At block 608, the user device 102 determines a selection. In some embodiments, the selection includes an enhanced audio selection. In some embodiments, the selection is made via the teleconference application. In some embodiments, the selection identifies a portion of the audio mixture to suppress. In some implementations, the user device 102 may receive a selection corresponding to the enhanced audio selection, such as from a user input. In some implementations, the inference system 110 may receive the selection during a teleconference session, such as during a video or audio call. In some implementations, the inference system 110 may receive the selection before the start of a teleconference session. In some implementations, such as for a communication application or other application other than a teleconference session, the inference system 110 may receive the selection during the session, before the session, or at any other appropriate time.

At block 610, the inference system 110 modifies a representation of the audio mixture to include a flag. In some embodiments, the flag corresponds to the selection. In some embodiments, the modified representation of the audio mixture is a vector of the user identifier and the audio mixture, concatenated with the flag. In some embodiments, the flag is a binary bit indicating whether the selection corresponds to background noise suppression or all noise suppression except the voice identified by the user identifier.

At block 612, the inference system 110 applies the modified representation of the audio mixture as input into an ML model. In some embodiments, the application of the modified the audio mixture as the input to the machine learning model causes the machine learning model to output a result. In some embodiments, the machine learning model is trained on clean speech data and background noise data. In some embodiments, the machine learning model is trained on the voice sample of the user during an enrollment phase.

At block 614, the inference system 110 enhances a user's voice and suppresses all other noise. In some embodiments, enhancing a user's voice and suppressing all other noise includes suppressing all noise of the audio mixture except a voice identified by the user identifier. In some embodiments, suppressing all noise of the audio mixture except the voice identified by the user identifier comprises suppressing a second voice of a second user.

At block 616, the inference system 110 suppresses background noise of the audio mixture. In some embodiments, suppressing the background noise of the audio mixture comprises preserving a second voice of a second user from being suppressed.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules, including one or more specific computer-executable instructions, that are executed by a computing system. The computing system may include one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of electronic devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. A computing environment can include any type of computer system, including, but not limited to, a computer system based on a microprocessor, a mainframe computer, a digital signal processor, a portable electronic device, a device controller, or a computational engine within an appliance, to name a few.

Conditional language such as, among others, “can,” “could,” “might,” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached FIGS. should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

What is claimed is:

1. A system for enhancing teleconference application audio, the system comprising:
memory that stores computer-executable instructions; and
a processor in communication with the memory, wherein the computer-executable instructions, when executed by the processor, cause the processor to:
obtain a voice sample of a user;
map the voice sample to a user identifier;
receive an audio mixture detected by an audio sensor;
receive a selection via a teleconference application that identifies a portion of the audio mixture to suppress;
modify a representation of the audio mixture to include a flag that corresponds to the selection; and
apply the modified representation of the audio mixture as an input into a machine learning model, wherein application of the modified representation of the audio mixture as the input to the machine learning model causes the machine learning model to one of:
suppress a background noise of the audio mixture, or
suppress all noise of the audio mixture except a voice identified by the user identifier.

2. The system of claim 1, wherein the modified representation of the audio mixture includes the user identifier, the audio mixture, and the flag.

3. The system of claim 1, wherein the flag is a binary bit indicating whether the selection corresponds to background noise suppression or all noise suppression except the voice identified by the user identifier.

4. The system of claim 1, wherein suppressing the background noise of the audio mixture comprises preserving a second voice of a second user from being suppressed.

5. The system of claim 1, wherein the machine learning model is trained on combined training data that comprises a first training data item,
wherein the first training data item includes a combination of a first type of clean speech data and a first type of background noise data, and
wherein the first type of clean speech data is identified as a target output.

6. The system of claim 1, wherein the machine learning model is trained on the voice sample of the user during an enrollment phase.

7. The system of claim 1, wherein the computer-executable instructions, when executed, further cause the processor to:
receive, during a teleconference session in which the selection is received, a second selection via the teleconference application that identifies a second portion of the audio mixture to suppress that is different than the portion of the audio mixture; and
cause the second portion of the audio mixture to be suppressed.

8. A method for enhancing audio of a communication application, the method comprising:
memory that stores computer-executable instructions; and
obtaining a voice sample of a user;
mapping the voice sample to a user identifier;
receiving an audio mixture detected by an audio sensor;
receiving a selection via a communication application that identifies a portion of the audio mixture to enhance;
modifying a representation of the audio mixture to include a flag that corresponds to the selection; and
applying the modified representation of the audio mixture as an input into a machine learning model, wherein application of the modified representation of the audio mixture as the input to the machine learning model causes the machine learning model to enhance a portion of the audio mixture corresponding to the selection.

9. The method of claim 8, wherein the modified representation of the audio mixture includes the user identifier, the audio mixture, and the flag.

10. The method of claim 8, wherein the flag is a binary bit indicating whether the selection corresponds to background noise suppression or all noise suppression except the voice identified by the user identifier.

11. The method of claim 8, wherein the portion of the audio mixture includes a background noise of the audio mixture or all noise audio mixture except a voice identified by the user identifier.

12. The method of claim 8, wherein the machine learning model is further caused to suppress a background noise of the audio mixture and preserve a second voice of a second user from being suppressed.

13. The method of claim 8, wherein the machine learning model is trained on the voice sample of the user during an enrollment phase.

14. A non-transitory, computer-readable medium comprising computer-executable instructions for enhancing audio of a communication application, wherein the computer-executable instructions, when executed by a computer system, cause the computer system to:
receive an audio mixture detected by an audio sensor;
receive a selection via the communication application that identifies a portion of the audio mixture to enhance;
modify a representation of the audio mixture to include a flag that corresponds to the selection; and
apply the modified representation of the audio mixture as an input into a machine learning model, wherein application of the modified representation of the audio mixture as the input to the machine learning model causes the machine learning model to enhance a portion of the audio mixture corresponding to the selection.

15. The non-transitory, computer-readable medium of claim 14, wherein the modified representation of the audio mixture includes a user identifier, the audio mixture, and the flag.

16. The non-transitory, computer-readable medium of claim 14, wherein the flag is a binary bit indicating whether the selection corresponds to background noise suppression or all noise suppression except a voice identified by a user identifier.

17. The non-transitory, computer-readable medium of claim 14, wherein the machine learning model is trained on a voice sample of a user during an enrollment phase.

18. The non-transitory, computer-readable medium of claim 15, wherein the portion of the audio mixture includes a background noise of the audio mixture or all noise audio mixture except a voice identified by the user identifier.

19. The non-transitory, computer-readable medium of claim 14, wherein the computer-executable instructions, when executed, further cause the computer system to suppress a second voice of a second user.

20. The non-transitory, computer-readable medium of claim 14, wherein the computer-executable instructions, when executed, further cause the computer system to preserve a second voice of a second user from being suppressed.
